(19) United States
(12) Patent Application Publication
(10) Pub. No.: US 2017/0220586 A1
(43) Pub. Date: Aug. 3, 2017

(54) ASSIGN PLACEMENT POLICY TO SEGMENT SET

(71) Applicant: HEWLETT PACKARD ENTRPRISE DEVELOPMENT LP, Houston, TX (US)

(72) Inventors: Boris Zuckerman, Andover, MA (US); Padmanabhan S. Nagarajan, Andover, MA (US)

(21) Appl. No.: 15/118,609

(22) PCT Filed: Feb. 14, 2014
(86) PCT No.: PCT/US2014/016435

§ 371 Date: Aug. 12, 2016

(51) Int. Cl. G06F 17/30

(52) U.S. Cl. CPC G06F 17/30082; G06F 17/30224; G06F 17/30203; G06F 17/30327; G06F 17/30091

(57) ABSTRACT

A plurality of segment sets of one or more storage segments of a distributed file system may be created and/or updated. The storage segments may be independently controlled. A placement policy may be assigned to each of the plurality of segment sets. The placement policy may control an initial placement and/or relocation of an object to the one or more storage segments for the assigned storage set.

### BACKGROUND

A distributed file system may refer to a system for storing and accessing files based on multiple storage nodes. The distributed file system may be based on a client/server architecture. In the distributed file system, one or more files stored at a storage device may be accessed, with proper authorization rights, by a remote client in a network via an intermediate server. The distributed system may use a uniform naming convention and a mapping scheme to keep track of where files are located.

Manufacturers, vendors, and/or service providers are challenged to provide improved mechanisms to transfer control of storage devices and/or select storage devices for storing files. Distributed file systems may make it easier to serve a large number of clients by providing a common pool of storage resources machines are not using their resources to store files.

### BRIEF DESCRIPTION OF THE DRAWINGS

The following detailed description references the drawings, wherein:

FIG. 1 is an example block diagram of a device to assign a placement policy to a segment set;

FIG. 2 is an example block diagram of a distributed file system including a device to assign a placement policy to a segment set;

FIG. 3 is an example block diagram of a computing device including instructions for assigning a placement policy to a segment set;

FIG. 4 is an example flowchart of a method for assigning a placement policy to a segment set; and

FIG. 5 is an example flowchart of a method for dynamic inheritance of placement policy.

### DETAILED DESCRIPTION

Specific details are given in the following description to provide a thorough understanding of embodiments. However, it will be understood that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

A distributed segmented parallel file system may be comprised out of a large number of storage components, e.g. storage segments, and a large number of Destination Servers (DS) controlling such storage components. The distributed segmented parallel file system may include storage segments with different characteristics. Some storage segments may be very efficient for storing big amounts of new data, while other storage segments may be more tuned to perform well with random reads. Further, some storage segments may be slower, but more energy efficient and more suitable for storing data that is not frequently accessed. Additionally, servers and associated storage segments may be geographically distributed.

An example distributed segmented parallel file system may be comprised out of thousands large storage segments. At any given time, the individual storage segments may be exclusively controlled by corresponding servers. However for load balancing purposes or due to component failures or maintenance reasons, this control over storage segments may migrate from one server to another. Servers may be connected to a storage segment ‘directly’, such as via a Direct-attached storage (DAS) model, or through various interconnect technologies, such as via a Fibre Channel (FC), Internet Small Computer System Interface (ISCSI), Serial Attached SCSI (SAS), etc. The distributed segmented parallel file system may also include client nodes that at given time do not control segments and can be used to run applications or provide access to the distributed segmented parallel file system through other protocols such as Network File System (NFS), Server Message Block (SMB), Hypertext Transfer Protocol (HTTP), File Transfer Protocol (FTP), etc.

The overall efficiency and reliability of the distributed segmented parallel file system may depend on flexibility and ability to select appropriate storage segments for different objects. In such an environment, Entry Point Servers (ES) may constantly have to make decisions about which segments should be chosen for newly created objects. Typically, such decisions are taken based on either hard-coded algorithms or on policies defined “globally” in hosting environments.

However, these decision-making mechanisms may not be able to dynamically change polices or set policies locally, such that different policies may be set for different directories or levels of a namespace. Moreover, such mechanisms may require frequent revalidation of intermediate nodes of a sub-tree of the namespace due to policy changes and/or migration of control over storage segments. Further, these mechanisms may not be responsive enough to react quickly to occasional changes of such policies, thus propagating such changes though potentially thousands of participating servers.

Examples may define placements rules or policies and associate them dynamically with places in the name space, as well as with the points of data origin. An example device may include a set unit and a policy unit. The set unit may create and/or update a plurality of segment sets of one or more storage segments of a distributed file system. The storage segments may be independently controlled. The policy unit may assign a placement policy to each of the plurality of segment sets. The placement policy may control an initial placement and/or relocation of an object to the one or more storage segments for the assigned storage set.

Thus, examples may provide a method, mechanism, and/or implementation for deciding placement of newly created objects in a highly scalable heterogeneous environment. Examples may address problems of different types of storage, geographical distribution, fault lines and associate that with different of data as well as define time and file attribute based tiering rules and describes constraints of their implementation.

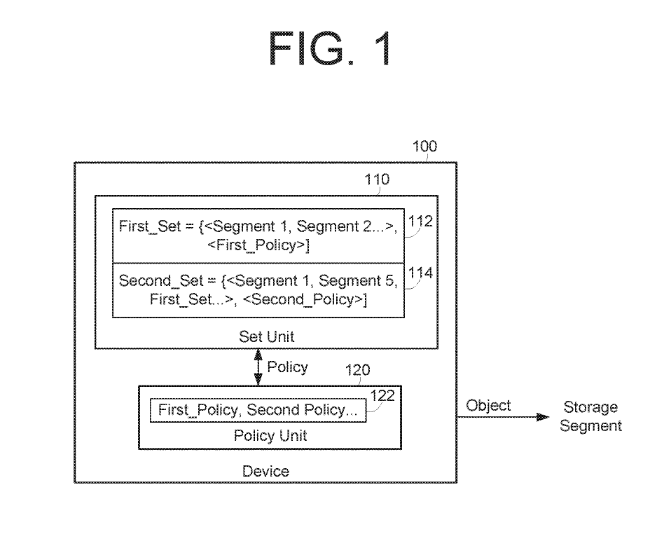

Referring now to the drawings, FIG. 1 is an example block diagram of a device 100 to assign a placement policy to a segment set. The device 100 may interface with or be included in any type of device that accesses a storage segment, such as a server, a computer, a network device, a wireless device, a thin client, and the like.

In FIG. 1, the device 100 shown to include a set unit 110 and a policy unit 120. The set and policy units 110 and 120 may include, for example, a hardware device including electronic circuitry for implementing the functionality described below, such as control logic and/or memory. In addition or as an alternative, the set and policy units 110 and 120 may be implemented as a series of instructions encoded on a machine-readable storage medium and executable by a processor.

The set unit 110 may create and/or update a plurality of segment sets of one or more storage segments (not shown) of a distributed file system. The storage segments may be independently controlled. Examples of the storage segments 210 may include individual solid state drives (SSDs), hard disk drive (HDDs) and/or any other type of storage device. The storage segments may located in geographically diverse areas and/or have diverse properties. For example, SSD storage segments may have lower latency but also a lower storage capacity than SSD storage segments.

Further, some storage segments may be closer to a first office location of a business while other storage segments may be closer a second location. The segments sets may represent logical groupings of the storage segments. Also, the segment sets may be stored at servers (not shown) or a database accessible by the servers. The policy unit 120 may assign a placement policy to each of the plurality of segment sets. The placement policy may control an initial placement and/or relocation of an object (not shown) to the one or more storage segments for the assigned storage set. For instance, each segment set may have a name and include a list of storage segments and a placement policy.

For example, FIG. 1 shows the policy unit 120 to include a plurality of policies 122. Further, the set unit 110 of FIG. 1 is shown to include two example segments sets 112 and 114. However, examples may include more or less than two segment sets. The first segment set 112 is shown to include at least first and second segments and be associated with a first policy. However examples of the segment set may include more or less than two storage segments sets. Here, the first policy may determine which of the storage segments of first set is to store an object.

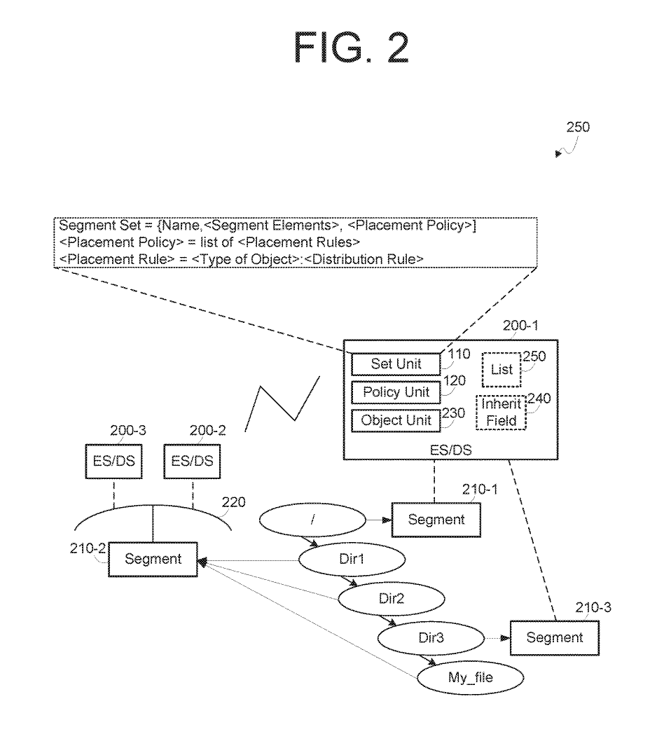

The second segment set 114 is shown to include the same first segment and a fifth segment and be associated with a second policy. The second policy may be different than the first policy. Hence, examples may allow for a storage segment to be included in more than one segment set. Further, the second segment set 114 is shown to include the first segment set 112. Thus, examples of the segment set may include another segment set as a subset. This subset may include one or more of the storage segments and be assigned a policy independent of the policy of the segment set including the subset. The set and policy units 110 and 120 will be explained in greater detail below with respect to FIG. 2

FIG. 2 is an example block diagram of a distributed file system 250 including a device 400 to propagate and assign a placement policy to a directory node. The device 200 may interface with or be included in any type of device that selects a storage segment, such as a server, a computer, a network device, a wireless device, a thin client, and the like.

The device 200-1 of FIG. 2 may include the functionality and/or hardware of the device 100 of FIG. 1. For example, the device 200-1 includes the set unit 110 and the policy unit 120 of the device 100 of FIG. 1. Further, the device 200-1 includes an object unit 230, an inherit field 240 and a list of intermediate directory nodes 250. The devices 200-2 and 200-3 may include any functionality and/or hardware similar to that of the device 200-1. For the sake of simplicity, only the device 200-1 will be described in detail.

The object unit 230 of the device 200-1 may include, for example, a hardware device including electronic circuitry for implementing the functionality described below, such as control logic and/or memory. In addition or as an alternative, the object unit 230 may be implemented as a series of instructions encoded on a machine-readable storage medium and executable by a processor. The inherit field 240 and the list 250 may be stored on in any electronic, magnetic, optical, or other physical storage device that contains or stores information, such as Random Access Memory (RAM), flash memory, SSD, HDD and the like. For instance, the inherit field 240 may be stored in a memory structure of the RAM, such as inodes or any other type of node or tree structure.

The distributed segmented parallel file system 250 may be comprised out of a large number of storage segments 210-1 to 210-3, and a large number of devices 200-1 to 200-3. The devices 200-1 to 200-3 and associated storage segments 210-1 to 210-3 may be geographically distributed. While three storage segments 210 are shown in FIG. 2, examples may include more or less than three storage segments 210, such as thousands of storage segments 210. Similarly, while three devices 200 are shown in FIG. 2, examples may include more or less than three devices 200, such as hundreds of devices 200.

At any given time, the storage segments 210-1 to 210-3 may be individually controlled by the corresponding devices 200-1 to 200-3. Here, the first and third storage segments 210-1 and 210-3 are controlled by the first device 200-1. Further, the second storage segment 210-2 is controlled by the second and third devices 200-2 and 200-3 via an interconnect 220. The interconnect 220 may include any type of device that provides a physical link between the devices 200-2 and 200-3 and the second storage segment 210-2, such as a network switch.

The distributed segmented parallel file system 250 may include a namespace. The namespace may provide a deterministic way of accessing objects by name, such as through a plurality of directories and/or files. The term directory may refer to a file system cataloging structure in which references to other computer files, and possibly other directories, are kept. The term object may refer to files and/or directories. Files may be organized by storing related files in the same directory.

The distributed segmented parallel file system 250 may include a hierarchical file system, where files and directories are organized in a manner that resembles a tree. In this file system, a directory contained inside another directory may be called a subdirectory. The terms parent and child may be used to describe the relationship between a subdirectory and the directory in which it is cataloged, the latter being the parent. The top-most directory in such a file system, which does not have a parent of its own, may be called the root directory.

As shown in FIG. 2, a file path is shown for the file “My_file,” where the file path is “/Dir1/Dir2/Dir/3/My_file.” The “/” may be the root directory, the first directory (Dir1) may be a subdirectory of the root directory, the second directory (Dir2) may be a subdirectory of the first directory, and the third directory (Dir3) may be a subdirectory of the second directory. The file “My_file” may be within the third directory and stored at the second segment 210-2. Further, the root directory may be stored at the first segment 210-1, the first directory may be stored at the second segment 210-2, the second directory may be stored at the second segment 210-2, the third directory may be stored at the third segment 210-2 and the file “My_file” may be stored at the second segment 210-2. Thus, more than one object, such as a directory or file, may be stored at a single segment 210, such as the second storage segment 210-2. Each part of the file path is stored at one of the storage segments 210.

To execute an operation, a client device (not shown), such as a computer, may request services from one of the devices 200-1 to 200-3 that control the storage segments 210-1 to 210-3 associated with objects involved in the operation. In this case, the devices 200-1 to 200-3 may be referred to as Destination Servers (DS). Further, any of the devices 200-1 to 200-3 may be referred to as Entry point Servers (ES), if the devices 200-1 to 200-3 are involved in the creation of a new object.

All participating nodes, such as the devices 200 and storage segments 210, may exchange messages over Ethernet or other network media. To achieve a higher degree of parallelism, individual elements of a hierarchical namespace may be widely distributed through the set of storage segments 210 and correspondently controlled and/or served by different servers 200.

For example, the second device 200-2, acting as an ES, may decide to place a new file (not shown) on the second storage segment 210-2 and have it be linked to the third directory dir3, which is stored on the third storage segment 200-3. However, the second device 200-2 may not have direct access to the third storage segment 210-3. Therefore, the second device 200-2 may act as an ES upon creating the new file at the second storage segment 210-2 and then may request the services of the first device 200-1 to link the new file to the third directory Dir3 stored at the third storage segment 210-2. Any of the devices 200 may act as an ES upon acting on a request, such as that from an application, NFS, CIFS, FTP or other server.

Some distributed segmented parallel file system operations may engage more objects and correspondently depend even to a greater degree on correct actions and coordination of a larger number of DSs. The devices 200 that control storage segments 210 may play the role of ES and/or DS. For instance, the device 200 may be an ES for distributed segmented parallel file system level requests originated locally and may be a DS for requests coming from other computers or client devices.

The object unit 230 may store the object to at least one of a plurality of storage segments 210 of one of the segment sets. For example, the object unit 230 of the first device 200-1 may be responsible for selecting one of the first and third storage segments 210-1 and 210-3 for storing an object.

As noted above, any of the devices 200 may include segment sets stored within the set unit 110, where segments sets each include a list of storage segments 210. The set unit 110 may create and/or update the segments sets based on differences in storage segment 210 characteristics, destination server (DS) associations, geographic distribution of the distributed file system, and the like. The storage segment 210 characteristics may include different latencies, energy efficiencies, optimization for reading random data, and optimization for storing faster large amounts of data.

For example, the set unit 110 may create a first segment set that lists ail storage segments 210 including SSDs, a second segment set that lists all storage segments 210 controlled by the first device 200-1, a third segment set that lists all storage segments 210 local to a geographic region, and the like. Examples may include numerous other types of factors for determining which storage segments to group into a segment set.

Each of the segments sets may be associated with a placement policy. At least two of the plurality of segments sets may be associated with different levels of a namespace. For example, the set unit 110 of the first device 200-1 may include a first segment set associated with the root node and a second segment set associated with the third directory Dir3. The set unit 110 may also include automatically defined segment sets, such as a host set. The host set may include all storage segments controlled by a specific server or device, such as the first device 200-1. The policy unit 120 may assign different placement policies to the at least two segment sets associated with different levels of the namespace. The namespace may be reconstructed at run-time of the file system. A value of a dynamically inheritable attribute may be associated with one or more entities, such as levels, of the file system. The dynamically inheritable attribute may relate to the placement policy.

The placement policy may consist of one or more placement rules and may include different placement rules for different types of the object. Types of the object to be stored may include regular files, directories, file replicas, directory replicas, all replicas, all objects, and the like. For example, a root segment set may be associated with the root node and include a plurality of host sets, such as that of the three devices 200-1 to 200-3. A rule of a placement policy associated with the root segment set may be a default policy that allocates an object according to a random weighting between all of the storages segments of the first segment set. A subdirectory segment set may be include all the storage segments storing subdirectories, such as Dir1, Dir2 and Dir3. A rule of a placement policy associated with a subdirectory segment set may direct an object to be stored to a same storage segment as its parent directory.

The placement rules may be flexible enough to accommodate a potential increase in the number of storage segments 210 and/or devices 200, as well as an occasional change of control of a storage segment 210 from one of the devices 200 to another of the devices 200. Yet the placement rules may also be generic enough to reflect potential differences in segment characteristics, DS associations, geographic distribution, etc. Moreover, the devices 200 may allow for defining of different placement rules for different levels, sub-trees, and/or subdirectories of the namespace.

The placement rules may be dynamic by nature because new storage segments 210 may be added any time. Also, new placement rules may be introduced through different ESs 200. In addition, the placement rules may include time characteristics of the object itself, as explained below. Further, the placement rules may be set and modified any time and such modifications may take instantaneous effects on behavior of the distributed segmented parallel file system, as explained below. As noted above, more than one of the segment sets may include a same one of the storage segments 210. Further, different rules may select the same storage segment 210. Elements of a file path of the namespace may be placed on different storage segments 210 and controlled by different servers 200.

The placement policy may control the initial placement of the object to one or more of the storage segments 210 based on a specified storage segment, random selection, a segment set of the storage segment, a directory of the storage segment, a destination server (DS) of the storage segment, a storage interface of the storage segment, weighting, a deterministic algorithm, and the like. The weighting may be based on free space, latency, a number of accesses of the storage segment and the like. The deterministic algorithm may be based on round robin, selecting a subset of the segment set.

For instance, the placement policy may direct all regular files to a HDD storage segment and all file replicas to a SSD storage segment, where the HDD and SSD storage segments 210 are included in the segment set associated with this placement policy. In this case, the placement policy may allow for lower latency for file that are being modified and/or commonly accessed. In another instance, the placement policy may place objects according to a weighted round robin schedule for the storage segments 210 included in the segment set associated with this placement policy, where the weighting is based on an amount of free space at each of the storage segments 210. Examples may include numerous other types of methodologies for distributing an object among storage segments or subsets of a segment set.

The placement policy may also control the relocation of the object to the one or more storage segments based on an attribute of the object. The attribute may relate to a size, ownership, object type, object name, a time characteristic of the object and the like. The time characteristic may relate to a time the object was accessed, a time the object was modified, a time an inode of the object was changed, and the like.

For example, the placement policy may dictate that objects owned a certain user are to be moved from a storage segment 210 controlled by the first device 200-1 to a storage segment 210 controlled by the second device 200-1, such as if the user is relocating to a different area. In another example, the placement policy may dictate that objects which have not been accessed or modified within a certain amount of time, to be moved from a lower latency storage segment 210 to a higher latency storage segment 210.

As noted above, the namespace may be organized according to a tree data structure including a plurality of nodes. Each of the segment sets may be associated with at least one of the nodes. For example, in FIG. 2, each element of the file path may correspond to a node, such that “/” may be a root node, “My_file” may a child node of “Dir3”, “Dir1” may a parent node of “Dir2” and the like. Further, an example segment set may be associated with “/” while another example segment set may be associated with “Dir3” and/or “/”, and the like.

Each of the nodes may be associated with the inherit field 240. The inherit field 240 may be a field that helps to detect changes in inheritable attributes, such as the placement policy. A change in the inherit field 240 may originate on the root node and values of the inherit field 240 may propagated to lower nodes, such as to objects lower in the tree. Thus, the inherit field 240 may be checked to determine if at least part of a placement policy at a higher node has descended to a lower node. For instance, a segment set associated with a child node may inherit at least part of a placement policy of a segment set associated with a parent node, if the segment set associated with the child node lacks a placement policy.

Further, when any placement policy is changed, the inherit field 240 of the root may be incremented and root delegations of the placement policy to lower nodes may be broken. Further, the copies of the root node may be refreshed at all of the ESs, as explained in further detail below. The inherit field 240 may be used to separately handle less frequent updates of the placement policy from more frequent updates of objects, such as files and directories.

By default, the file system may apply a default segment set at the level of the file system root node. However, it may be possible to set up association between a name of a segment set and any directory node in the name space recording the segment set name in the file system specific extended attributes. Such a segment set and associated placement policy may be used for selecting storage segments during creation of new objects at all descending nodes. In the case of a segment set, a simple replacing inheritance may be applied. A segment set recorded deeper in the name space may take precedence over a segment set recorded higher up.

Also, at least part of the placement policy of the segment set associated with the child node may complement and/or take precedence over at least part of the placement policy of the segment set associated with the parent node, if at least part of the placement policy of the segment set associated with the child node contradicts and/or is more specific than at least part of the placement policy associated with the parent node.

For example, assume we have a following file path: /ISS_HOME/store_all/archive. Further, assume, the each element of this file path is associated with a separate node and a separate segment set. The placement policy associated with element “ISS_HOME” may direct all objects to be stored to HDD storage segments 210. This placement policy may also be inherited by the child node at element “store_all.” However, the placement policy associated with the element “store_all” may include a more specific rule that conflicts with at least part of the policy of the element “ISS_HOME”.

For instance, the placement policy associated with element “store_all” may direct all directory information to be stored to SSD storage segments 210. This placement policy may also be inherited by the child node at element “archive.” However, the placement policy associated with the element “archive” may include an additional rule that complements at least part of the placement policy of the element “store_all”. For instance, the placement policy of the element “archive” may include a rule that all files be stored to SATA storage segments 210.

As noted above, the placement policies may be inheritable and may be changed dynamically for a node. For instance, the placement policies may need refreshing because they may be changed by DSs, and ESs may not know about these changes. However, propagating the changed placement policies to all child nodes inheriting the changed placement policy may be inefficient and costly. Instead, the changed placement policies may be propagated infrequently, such as only when the system needs the updated placement policies.

The above placement policies may be stored as extended attributes of objects, such as directories, at the devices 200 and/or storage segments 210. As explained below, the inherit field 240 may be used to determine which of the placement polices have changed or are to be inherited by a lower node. The list 250 may be made if a value of the inherit field 240 is different for the child and root nodes. The list 240 may include all of the nodes from a child node to a root node of the child node. The value of the inherit field 240 of the root node may be propagated to the inherit fields 240 of the nodes of the list 250 in consecutive order starting with the child node until the inherit field 240 of the root node matches a current node of the list. Thus, examples may reduce or prevent frequent revalidation of intermediate nodes and propagate policy changes quickly to participating servers.

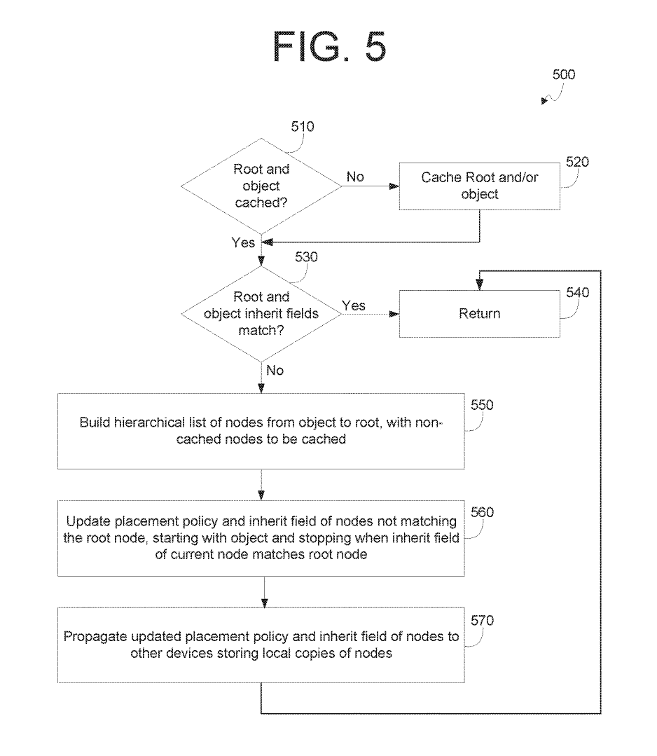

While the inherit field 240 is shown to relate to the placement policy, examples of the inherit field 240 may relate to various other types of information to be inherited, such as security constraints, snapshot identities, policies for virus checking, replication rules, and the like. Efficient proliferation of inherited attributes such as segment set based placement and relocation policies may be especially challenging in the highly distributed segmented file system environment. An operation of dynamically changing and inheriting placement policy is explained below in FIG. 5.

FIG. 5 is an example flowchart of a method for dynamic inheritance of placement policy, such as for propagating a dynamically inheritable attribute (e.g. a placement policy) during a validation procedure. Although execution of the method 500 is described below with reference to the device 200, other suitable components for execution of the method 500 can be utilized, such as the device 100. For example, the method 500 may be performed by an entry point server (ES) and used to validate a dynamically inheritable attribute (e.g. a segment set based placement policy) at a given file system entity, referred to as “my_object” in FIG. 5.

Additionally, the components for executing the method 500 may be spread among multiple devices (e.g., a processing device in communication with input and output devices). In certain scenarios, multiple devices acting in coordination can be considered a single device to perform the method 500. The method 500 may be implemented in the form of executable instructions stored on a machine-readable storage medium, such as storage medium 320, and/or in the form of electronic circuitry.

The determination that a dynamically inheritable attribute of a file system entity is to be refreshed can be part of a validation procedure, in which the value of the dynamically inheritable attribute for a given file system entity is validated. For example, a validation procedure can be performed of all file system entities along a particular path from a particular file system entity. For performance reasons, techniques or mechanisms according to some implementations are provided to intelligently determine that certain file system entities along the path do not have to be re-validated provided certain conditions are satisfied, as discussed further below. In one example traversing the entire chain of nodes (corresponding to a sub-tree of file system entities), may be avoided during a validation procedure.

In some examples, a dynamically inherited generation field, e.g. inherit field 240 in an in-core (also referred to as in-memory) inode representing a file system entity may be used during a validation procedure to determine when traversal of a chain of nodes can be stopped. The inherit field 240 may be maintained by ESs, such as the device 200, in in-core inodes and copied from the parent of the inode during the process of propagation of a dynamically inheritable attribute (e.g. a placement policy). The inherit field 240 may be updated at the root of the file system whenever a dynamically inheritable attribute is updated, such as in response to updating a segment set based placement policy or rule at any level of the name space hierarchy.

The inherit field 240 may be changed (e.g. monotonically incremented) at the root node of the file system with respective changes of the corresponding dynamically inheritable attribute (e.g. to a segment set based placement policy). The inherit field 240 may be propagated from the root node to other nodes during lookups or during a validation procedure to validate the dynamically inheritable attribute (e.g. a segment set based placement policy).

At block 510, the device 200 may determine if a local copy of an object, such as file or directory, and a local copy of the root node are both cached. If either is not cached, the device 200 may cache the object or root node at block 520 and then proceed to block 530. If both the object and root node are already cached, the method 500 may flow directly from block 510 to block 530. At block 530, the device 200 may determine if the inherit fields 240 of the root node and the object match. If the inherit fields 240 of the root node and the object do match, the method 500 may flow to block 540, where the method 500 is completed.

Thus, the method 500 may check for certain conditions, such as (1) whether the root of the file system is cached at the ES, (2) whether the given file system entity being validated (e.g. my_object) is cached, and (3) whether the inherit field 240 of the root is the same as the inherit field 240 of the given file system entity my_object. If all three conditions checked at blocks 510 to 530 are true, then the method 500 may exit at block 540.

This is because the inherit field 240 of the file system entity may be the same as the inherit field 240 of the root node, which may infer that the dynamically inheritable attribute of the file system entity is up-to-date and does not have to be refreshed. Stopping the validation of the dynamically inheritable attribute (e.g. a segment set based placement policy) once it is confirmed that the inherit field 240 of the file system entity being checked is the same as the inherit field 240 of the root allows for more efficient validation, since time and resources are not wasted in trying to validate the dynamically inheritable attribute that is already refreshed.

Otherwise, if the inherit fields 240 of the root node and the object do no match, the method 500 may flow from block 530 to block 550, where the device 200 may build a hierarchical list 250 of nodes from the object to the root node. The device 200 may cache any nodes in this list 250 that are indicated as not being cached at the device 200. Nodes associated with file system entities in the hierarchy are iteratively added at block 550 to the list 250 so long as the inherit field 240 of the corresponding file system entity does not match the inherit field 240 of the root node. The adding of nodes to the list 250 may stops when the inherit field 240 of a corresponding file system entity matches the root node's inherit field 240.

If the root is not cached or if my_object is not cached, then the corresponding inherit field 240 may be not locally accessible at the device 200 or ES. The device 200 or ES may build at block 550 a list 250 of all nodes in the hierarchy from my_object to the root node. As part of the process of building the list 250, the device 200 or ES may retrieve information pertaining to the root node from the corresponding DS (unless such information is already cached at the ES) and retrieve information pertaining to my_object from the corresponding DS (unless such information is already cached at the ES). Moreover, the ES may further retrieve information pertaining to any intermediate file system entities between my_object and the root node (unless any such information associated with a given intermediate object is already cached at the ES).

Then, at block 560, the device 200 may update the placement policy and inherit field 240 of nodes not matching the root node. This process may begin at the object and stop when the inherit field 240 of the current node matches the root node.

Thus, after the list 250 has been built at block 550, the value of the dynamically inheritable attribute (e.g., a segment set based placement policy) is propagated at block 560 from the first node in the list 250, where the fist node is typically the root, node to other nodes in the list 250. The propagation of a dynamically inheritable attribute is made only to the file system entities associated with nodes in the list 250—these are the file system entities having values for the inherit field 240 that do not match that of the root node. This may help to reduce traffic and resource consumption associated with propagation of dynamically inheritable attributes, which can grow rapidly in a large distributed storage system.

Lastly, at block 570, the device 200 may propagate the updated placement policy and/or inherit field of the nodes to other devices 200 storing local copies of these nodes. After propagation of the value of the dynamically inheritable attribute to the file system entities associated with nodes in the list 250, the method 500 flows back to block 540 and exits.

For example, the third device 200-3 may alter the placement policy associated with the first directory Dir1. As a result, the third device 200-3 may also increment the inherit field 240 associated with the first directory Dir1, such as from “1” to “2”. Further, the third device 200-3 may request the first device 200-1 to increment the inherit field 240 of the root node “/”, such as from 1 to 2. A remainder of the nodes of the namespace, such as the second and third directories Dir2 and Dir3 and the my_file may retain values of “1” for their respective inherit fields 240.

As each of the devices 200-1 to 200-3 may have cached or stored local copies of at least part of the namespace, the first device 200-1 may send an invalidation request for the root node “/” to the second device 200-2 and the third device 200-3 may send an invalidation request for the first directory Dir1 to the second and third devices 200-2 and 200-3. Thus, for example, the second device 200-2 may mark local copies of the root and first directories “/” and Dir 1 as being “not cached” or current. Assuming, a user then wishes to modify my_file through the second device 200-2, the second device 200-2 may first compare the inherit fields 240 of the root node “/” and my_file. Initially, the second device 200-2 may determine that the local copy of the root node “/” cannot be trusted as it is “not cached” or current. The second device 200-2 may then reread the “root node” from the first device 200-1.

Next, the second device 200-2 may determine that the inherit fields 240 of the root node “/” and my_file do not match. For instance, the inherit field 240 of the root node “/” may be 2 and the inherit field 240 of my_file may be 1. At this point, the second device 200-2 may build a list 250 of nodes hierarchically linking from my_file to the root node “/”. Then, the placement policy may be updated, if applicable, starting with my_file. After the placement policy is deemed to be current, the inherit value 240 of my_file may be updated at the second device 200-2 to match that of the root node “/”. A similar process may be carried out the third directory Dir3 and then the second directory Dir2.

Upon reaching the first directory Dir1, the inherit fields 240 of the first directory Dir1 and the root directory “/” may match. Thus, all of the nodes of the list 250 may all be up to date with respect to placement policies and inherit field 240 values. Moreover, if the list 250 is generated again in the future, fewer nodes may now need to be updated and thus the matching of the inherit fields 240 may cease at a lower node level. Next, the second device 200-2 may propagate the updated list 250 to the first and third devices 200-1 to and 200-3, so that these devices may also update the placement policies and inherit field 240 values for the nodes in the list 250.

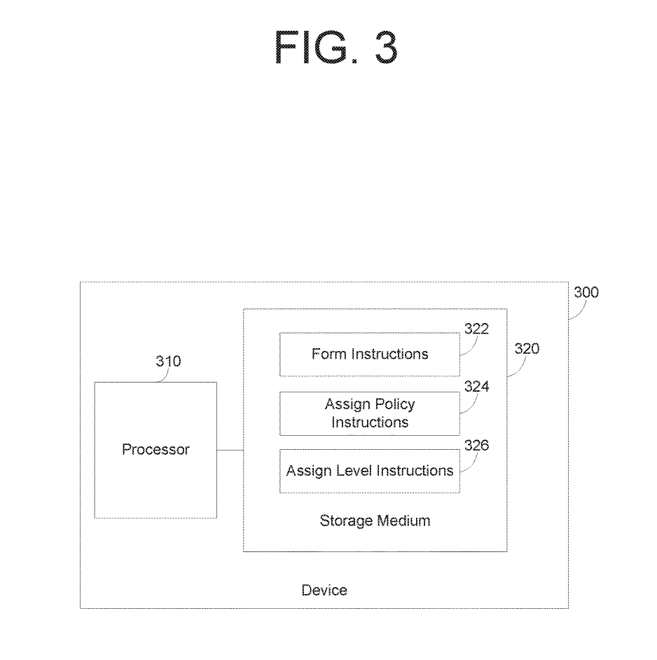

FIG. 3 is an example block diagram of a computing device 300 including instructions for assigning a placement policy to a segment set. In the embodiment of FIG. 3, the computing device 300 includes a processor 310 and a machine-readable storage medium 320. The machine-readable storage medium 320 further includes instructions 322, 324 and 326 for assigning a placement policy to a segment set.

The computing device 300 may be included in or part of, for example, a microprocessor, a controller such as a memory controller, a memory module or device, a notebook computer, a desktop computer, an all-in-one system, a server, a network device, a wireless device, or any other type of device capable of executing the instructions 322, 324 and 326. In certain examples, the computing device 300 may include or be connected to additional components such as memories, controllers, etc.

The processor 310 may be, at least one central processing unit (CPU), at least one semiconductor-based microprocessor, at least one graphics processing unit (GPU), a microcontroller, special purpose logic hardware controlled by microcode or other hardware devices suitable for retrieval and execution of instructions stored in the machine-readable storage medium 320, or combinations thereof. The processor 310 may fetch, decode, and execute instructions 322, 324 and 326 to implement assigning the placement policy to the segment set. As an alternative or in addition to retrieving and executing instructions, the processor 310 may include at least one integrated circuit (IC), other control logic, other electronic circuits, or combinations thereof that include a number of electronic components for performing the functionality of instructions 322, 324 and 326.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for assigning the placement policy to the segment set.

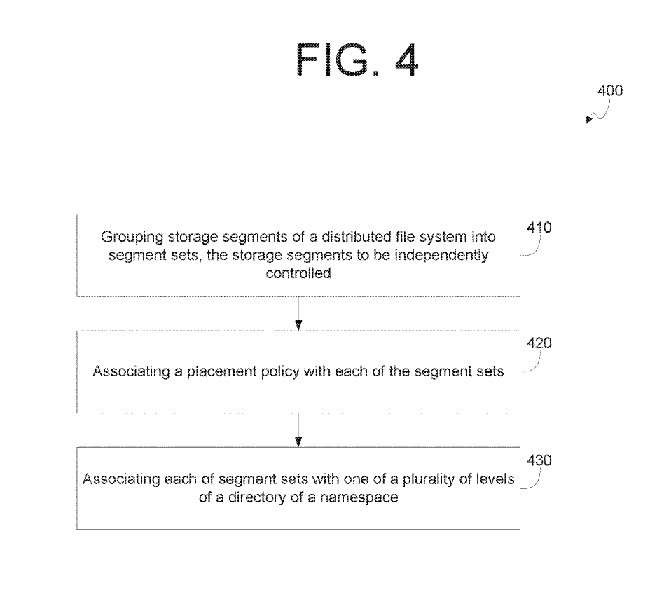

Moreover, the instructions 322, 324 and 326 when executed by a processor (e.g., via one processing element or multiple processing elements of the processor) can cause the processor to perform processes, such as, the process of FIG. 4. For example, the form instructions 322 may be executed by the processor 310 to form a plurality of segment sets from a plurality of storage segments of a distributed file system. The storage segments are independently controlled. The assign policy instructions 324 may be executed by the processor 310 to assign a separate placement policy to each of the segment sets.

The assign level instructions 326 may be executed by a processor 310 to assign each of the segment sets to one of a plurality of levels of a namespace. Each of the levels of the namespace may be assigned to at least one of the segment sets. An object may be at least one stored to and moved from at least one of the storage segments based on the placement policy of the segment set. The placement policy may include different rules for different types of objects.

FIG. 4 is an example flowchart of a method 400 for assigning a placement policy to a segment set. Although execution of the method 400 is described below with reference to the device 200, other suitable components for execution of the method 400 can be utilized, such as the device 100. Additionally, the components for executing the method 400 may be spread among multiple devices (e.g., a processing device in communication with input and output devices). In certain scenarios, multiple devices acting in coordination can be considered a single device to perform the method 400. The method 400 may be implemented in the form of executable instructions stored on a machine-readable storage medium, such as storage medium 320, and/or in the form of electronic circuitry.

At block 410, the device 200 may group storage segments 210 of a distributed file system into segment sets. The storage segments 210 may be independently controlled. The grouping at block 410 may form the segments sets based on differences in at least one of in segment characteristics, destination server (DS) associations, and geographic distribution of the distributed file system.

At block 420, the device 200 may associate a placement policy with each of the segment sets. At block 430, the device 200 may associate each of segment sets with one of a plurality of levels of a directory of a namespace. Each of the placement policies may include one or more that control placement of individual objects at least one and from the storage segments. At least two of the segments sets at different levels of the directory may be associated with at least one different rule.

We claim:

1. A device, comprising:
a set unit to at least one of create and update a plurality of segment sets of one or more storage segments of a distributed file system, the storage segments to be independently controlled; and
a policy unit to assign a placement policy to each of the plurality of segment sets, the placement policy to control at least one of an initial placement and relocation of an object to the one or more storage segments for the assigned storage set.

2. The device of claim 1, wherein,
at least two of the plurality of segments sets are associated with different levels of a namespace, and
the policy unit is to assign different placement policies to the at least two segment sets associated with different levels of the namespace.

3. The device of claim 1, wherein,
the placement policy includes different rules for different types of the object,
the set unit is to at least one of create and update the segments sets based on differences in at least one of storage segment characteristics, destination server (DS) associations, and geographic distribution of the distributed file system, and
storage segment characteristics include at least one of different latencies, energy efficiencies, optimization for reading random data, and optimization for storing faster large amounts of data.

4. The device of claim 1, wherein,
the placement policy is to control the initial placement of the object to the one or more storage segments based on at least one of a specified storage segment, random selection, segment set of the storage segment, directory of the storage segment, destination server (DS) of the storage segment, storage interface of the storage segment, weighting, and a deterministic algorithm,
weighting is based on at least one of free space, latency and number of accesses of the storage segment, and
the deterministic algorithm is based on at least one of round robin and selecting a subset of the segment set.

5. The device of claim 1, wherein,
the placement policy is to control the relocation of the object to the one or more storage segments based on an attribute of the object,
the attribute is to relate to at least one of a size, ownership, object type, object name, and a time characteristic of the object, and
the time characteristic is to relate to at least one of a time the object was accessed, a time the object was modified, and a time an inode of the object was changed.

6. The device of claim 1, wherein,
the namespace is organized according to a tree data structure including a plurality of nodes,
each of the segment sets is associated with at least one of the nodes, and
each of the nodes is associated with an inherit field, the inherit field to be used to determine if at least part of a placement policy at a higher node has descended to a lower node.

7. The device of claim 5, wherein,
a segment set associated with a child node inherits at least part of a placement policy of a segment set associated with a parent node, if the segment set associated with the child node lacks a placement policy, and
at least part of the placement policy of the segment set associated with the child node at least one of complements and takes precedence over at least part of the placement policy of the segment set associated with the parent node, if at least part of the placement policy of the segment set associated with the child node at least one of contradicts and is more specific than at least part of the placement policy associated with the parent node.

8. The device of claim 5, wherein,
a list is made of nodes from a child node to a root node of the child node, if a value of the inherit field is different for the child and root nodes, and
the value of the inherit field of the root node is propagated to the inherit fields of the nodes of the list in consecutive order starting with the child node until the inherit field of the root node matches a current node of the list.

9. The device of claim 1, wherein,
at least one of plurality of segment sets includes a subset of one or more of the storage segments,
the subset is to be assigned a policy independent of the policy of the segment set including the subset.

10. The device of claim 1, further comprising:
an object unit to store the object to at least one of a plurality of storage segments of one of the segment sets, wherein
the types of objects includes at least one of regular files, directories, file replicas, directory replicas, all replicas, all objects.

11. The device of claim 1, wherein,
more than one of the segment sets includes a same one of the storage segments,
different rules select the same storage segment, and
elements of a file path of the namespace are placed on different storage segments and controlled by different servers.

12. A method, comprising:
grouping storage segments of a distributed file system to segment sets, the storage segments to be independently controlled;
associating a placement policy with each of the segment sets; and
associating each of segment sets with one of a plurality of levels of a directory of a namespace, wherein,
each of the placement policies includes one or more rules that control placement of individual objects at least one of to and from the storage segments.

13. The method of claim 12, wherein,
the grouping forms the segments sets based on differences in at least one of in segment characteristics, destination server (DS) associations, and geographic distribution of the distributed file system, and
at least two of the segments sets at different levels of the directory are associated with at least one different rule.

14. A non-transitory computer-readable storage medium storing instructions that, if executed by a processor of a device, cause the processor to:
form a plurality of segment sets from a plurality of storage segments of a distributed file system, the storage segments to be independently controlled;
assign a separate placement policy to each of the segment sets; and
assign each of the segment sets to one of a plurality of levels of a namespace, wherein
each of the levels of the namespace is assigned to at least one of the segment sets.

15. The non-transitory computer-readable storage medium of claim 14, wherein,
an object is at least one stored to and moved from at least one of the storage segments based on the placement policy of the segment set, and
the placement policy includes different rules for different types of objects.
